(19) United States
(12) Patent Application Publication
(10) Pub. No.: US 2001/0027608 A1
(43) Pub. Date: Oct. 11, 2001

(54) Shaving apparatus particularly useful for wet shaving with an electrical shaver

(76) Inventor: Benjamin J. Barish, Tel Aviv (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 09/882,070

(22) Filed: Jun. 18, 2001

Related U.S. Application Data
(63) Continuation-in-part of application No. 09/644,583, filed on Aug. 24, 2000.
Application No. 09/644,583 is a continuation-in-part of application No. 09/312,765, filed on May 17, 1999, now Pat. No. 6,226,870.

(51) Int. Cl. B26B 19/14

(52) U.S. Cl. 30/34.2; 30/43.6

(57) ABSTRACT

A shaver for shaving hair from skin includes a cutter head having at least one cutter unit and at least one relatively sharp scraper edge located on the cutter head so as to be pressable into the skin forwardly of the cutter unit to erect hairs in the skin and to tauten the skin in advance of the cutter unit as the cutter head is moved across the skin.

### RELATED APPLICATIONS

The present application is a Continuation-in-Part of application Ser. No. 09/644,583 filed Aug. 24, 2000, which in turn is a Continuation-in-Part of application Ser. No. 09/312,765 filed May 17, 1999, now U.S. Pat. No. 6,226,870.

### FIELD AND BACKGROUND OF THE INVENTION

The present invention relates to shaving apparatus. The invention is particularly applicable to electrical shavers of the type including one or more rotary cutter members driven by an electrical motor, and is therefore described below with respect to such shavers.

For many years two basically different techniques have been used for shaving: (a) the “wet shave”, using a razor blade (straight blade or safety blade) and soap, lather, or a shaving cream for lubricating the skin and/or softening the hairs; and (b) the “dry shave”, using an electrical shaver on a dry skin. The main advantages of the “wet shave” are the ability of obtaining a close shave, the refreshing after-feeling produced after the shave, and the convenience of cleaning the shaver by merely rinsing the blade. The main advantages of the “dry shave” are the convenience of shaving almost whenever and wherever desired, the reduced danger of nicking, cutting or irritating the skin, and the elimination of the expense of frequent blade replacement since electrical shavers are generally self-sharpening during use.

Recently, several manufacturers have introduced electrical shavers for wet shaving. One type of electrical shaver is advertised for use with soap and water; whereas another type is advertised for use with an emulsion cream and includes a dispenser for dispensing the cream during use.

I have noted that when an electrical shaver is used for wet shaving, whether with soap and water, a cream, emulsion or other substance for lubricating the skin, the lubricating substance also wets the hairs in the skin, and therefore the shaver head tends to glide over the hairs. As a result, it fails to pick-up or closely cut some hairs such that the shave tends to be less close than with a blade.

### OBJECTS AND BRIEF SUMMARY OF THE INVENTION

An object of the present invention is to provide a shaver having advantages in the above respects. Another object of the invention is to provide an electrical shaver particularly adaptable for wet shaving.

According to one aspect of the present invention, there is provided a shaver for shaving hair from skin, comprising: a manually-grippable housing, and a cutter head carried by the housing; the cutter head including a holder having at least one cutter unit to be pressed into contact with, and to be moved along, the skin to be shaved, and a skin engaging surface circumscribing the cutter unit; characterized in that the cutter head further includes at least one relatively sharp scraper edge located on the cutter head so as to be pressable into the skin forwardly of the cutter unit, to erect hairs in the skin, and to tauten the skin, in advance of the cutter unit as the cutter head is moved across the skin.

An electrical shaver provided with a such a relatively sharp scraper edge may thus be used to engage and erect the hairs in advance of the cutter unit, and also to tauten the skin before engaged by the cutter unit, in a manner similar to the action of the two-blade or three-blade safety razor. Such a shaver thereby better assures a cleaner and closer shave than heretofore normally obtainable with an electrical shaver.

According to a further feature in the preferred embodiments of the invention described below, the relatively sharp scraper edge is located on the cutter head such that the relatively sharp scraper edge is pressed into the skin to erect the hairs, and to tauten the skin, by tilting the cutter head with respect to the skin to bring the axis of the cutter head to an oblique angle with respect to the skin. Such a feature enables the user to render the scraper edge effective only when desired, by merely tilting the shaver with respect to the skin to be shaved, thereby minimizing the possibility of irritating the skin by the scraper edge when a scraping action is not needed.

Several embodiments of the invention are described below for purposes of example.

In some described embodiments, the relatively sharp scraper edge is defined by an edge of the skin engaging surface of the shaver. In these described embodiments, the skin engaging surface has an inner side face facing the cutter unit, an outer side face facing away from the cutter unit, and an outer skin-contact face joining the inner and outer side faces; the relatively sharp scraper edge being formed in the juncture of the outer skin-contact face with the outer side face. In one of the latter embodiments, the relatively sharp scraper edge is defined by a sharp corner at this juncture, whereas in another described embodiment, it is defined by an outward extension of the skin-contact face at this juncture.

Another embodiment is described wherein the relatively sharp scraper edge is formed in the holder between the skin engaging surface and an outer edge of the holder. In this embodiment the relatively sharp scraper edge is defined by a relatively sharp projection extending over a recessed formation formed in the holder between the relatively sharp projection and the outer edge of the holder.

According to further features in the latter embodiment, the cutter head includes a plurality of the cutter units, and the relatively sharp scraper edge is formed in the holder at least along one side thereof between at least two of the cutter units and the respective outer edge of the holder.

According to another aspect of the present invention, there is provided an electrical shaver for shaving hair from skin, comprising: a manually-grippable housing having a cutter head removably attachable thereto along an outer edge of the cutter head; the cutter head including a holder having a skin engaging surface to engage the skin to be shaved, and a plurality of cutter units within the skin engaging surface to be pressed into contact with, and to be moved along, the skin to be shaved; the cutter head further including at least one relatively sharp scraper edge located on the cutter head such that, when the cutter head is tilted with respect to the skin to bring the skin engaging surface of the cutter head to an oblique angle with respect to the skin, the relatively sharp scraper edge is pressed into the skin forwardly of the cutter units to erect hairs in the skin, and to tauten the skin, in advance of the cutter units as the cutter head is moved across the skin.

Further features and advantages of the invention will be apparent from the description below.

### BRIEF DESCRIPTION OF THE DRAWINGS

The invention is described below with respect to the accompanying drawings, wherein:

FIG. 1 illustrates one form of rotary-type electrical shaver constructed in accordance with the present invention;

FIG. 2 is a front plan view illustrating the cutter head in the electrical shaver of FIG. 1;

FIG. 3 is an enlarged fragmentary view, partly in section, illustrating the present construction of the cutter head in the normal, skin-disengaged, position of the respective cutter unit;

FIG. 4 is a view corresponding to that of FIG. 3, but showing the skin-engaging position of the cutter unit during shaving;

FIG. 5 is a view corresponding to that of FIG. 4 but showing a modification in the construction of the shaver head to incorporate a relatively sharp scraper edge in accordance with one embodiment of the present invention'

FIG. 6 is a view corresponding to that of FIG. 5 but illustrating a second embodiment of the present invention;

FIG. 7 is a view corresponding to that of FIG. 2 but illustrating a third embodiment of the invention;

FIG. 8 is an enlarged fragmentary view along line VIII-VIII of FIG. 7;

FIG. 9 is a front plan view illustrating another type of rotary-electrical shaver;

FIG. 10 is an enlarged fragmentary view along line X-X of FIG. 9 illustrating a prior art construction of such an electrical shaver;

FIG. 11 is a view corresponding to that of FIG. 10 but illustrating a modification in the construction of the cutter head in accordance with another embodiment of the present invention; and

FIG. 12 is a view corresponding to that of FIG. 11 but illustrating a modification in accordance with yet another embodiment of the present invention.

### DESCRIPTION OF PREFERRED EMBODIMENTS

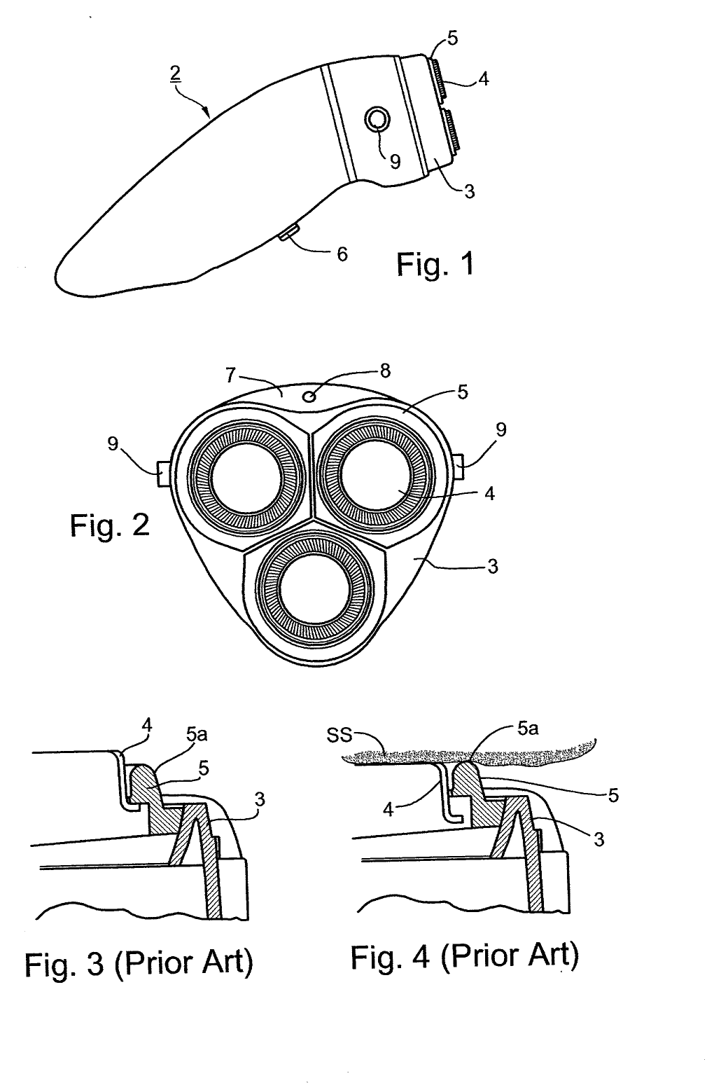

FIGS. 1-4 illustrate an electrical shaver of the rotary type as widely sold by Philips Corporation and having features described, for example, in their U.S. Pat. No. 5,625,950, which description is hereby formed herein by reference. The particular shaver illustrated is the Philips “Philishave Cool Skin” model which includes a built-in dispenser for dispensing a cream during shaving.

The illustrated electrical shaver includes a manually-grippable housing, generally designated 2, having a detachable cutter head holder 3 at one end for holding three cutter units, each generally designated 4, in a triangular array as shown in FIG. 2. Each cutter unit 4 is circumscribed by a skin engaging surface in the form of a rim 5 which engages and supports the skin during the shaving operation.

As known in such electrical shavers, each cutter unit 4 includes an external cutter member formed with a plurality of hair-entry slits, and an inner cutter member rotatable within the outer cutter member to cut the hairs received within the hair-entry slits. Each cutter unit 4 is depressible within the skin supporting rim 5 during the shaving operation, as shown in FIG. 4, to slightly tauten the skin before engaged by the cutting unit 4.

The shaver illustrated in FIGS. 1-4 further includes a push-button switch 6 for operating an electrical motor within housing 2, and a compartment 7 for discharging a small quantity of cream via an opening 8 upon manual depression of either of two side buttons 9.

Such electrical shavers are well known and widely available on the market in various models, with or without the cream dispenser. Accordingly, further details of the construction and operation of the electrical shaver illustrated in FIGS. 1-4 are not set forth herein.

In the commercial models of such shavers, and as clearly illustrated in the above-cited U.S. Pat. No. 5,625,950, the skin supporting rim 5 around each of the cutter units 4 has a rounded outer face, shown at 5a, presumably intended to minimize the resistance of the movement of the cutter head across the surface to be shaved during a shaving operation.

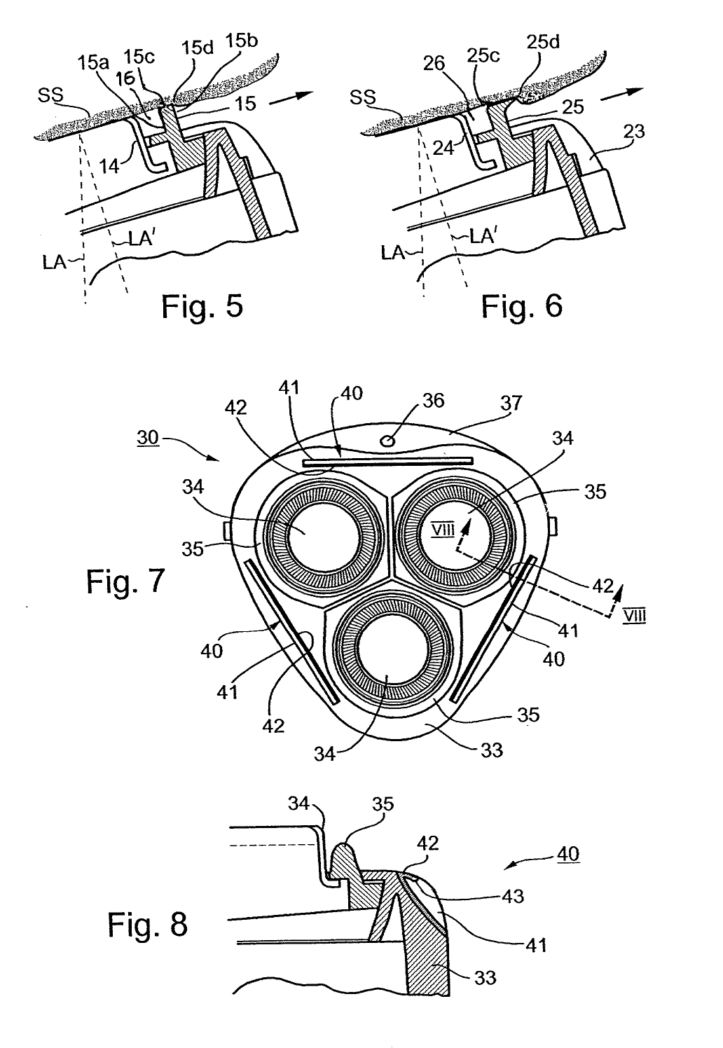

FIG. 5 is a view corresponding to that of FIG. 4 but illustrating the present invention implemented as a modification in the construction of the skin supporting rim. In the modification illustrated in FIG. 5, the holder 13 of the cutter head also includes a cutter unit 14 (only the outer member being shown) circumscribed by a skin supporting rim 15. In this case, however, the skin supporting rim 15 is formed with a relatively sharp scraper edge 15a located so as to be pressed into the skin SS to be shaved forwardly of the cutter unit 14, to erect hairs in the skin, and to tauten the skin, in advance of the cutter unit as the cutter head is moved across the skin.

More particularly, a shown in FIG. 5, the skin supporting rim 15 includes an inner side face 15a facing the cutter unit 14, an outer side face 15b facing away from the cutter unit, and an outer skin-contact face 15c joining the two side faces 15a, 15b to contact and support the skin SS when the cutter unit is pressed inwardly during shaving. In the embodiment illustrated in FIG. 5, the relatively sharp scraping edge is defined by a sharp corner 15d at the juncture of the outer skin-contact face 15c and the outer side face 15b of the skin supporting rim 15.

Preferably, the outer tip of the scraping edge defined by the sharp corner 15d is substantially flush with the skin-contact face 15c of the skin supporting rim 5, or recessed slightly inwardly of that surface, so that the sharp edge will not be pressed significantly into the skin during a normal shaving operation when the axis of the shaver unit is perpendicular to the skin SS to be shaved. This minimizes irritating the skin by the sharp edge during a normal shaving operation. When it is desired to make the scraper edge 15d effective to scrape the skin, the electrical shaver would be tilted slightly with respect to the skin SS to bring the longitudinal axis of the cutter unit 14 to an oblique position with respect to the skin in order to produce the scraping action which erects the hairs and tautens the skin in advance of the cutter unit.

In FIG. 5, the normal position of the shaver unit is indicated by its longitudinal axis LA, and the tilted position is indicated by its longitudinal axis LA′. Thus, during a normal shaving operation, the shaver would be oriented with its longitudinal axis LA substantially perpendicular to the skin as the shaver is pressed against the skin. When a scraping action is desired, the shaver could be tilted to bring its longitudinal axis to the tilted position, shown at LA′, with respect to the skin. Such an arrangement thus enables the scraper edge to be selectively activated to perform its scraping function as and when desired, with a minimum of irritation of the skin during normal shaving when the cutter head is pressed perpendicularly against the skin.

As also shown in FIG. 5, the inner face of the skin supporting rim 15 is formed with an annular recess defining a space or gap 16 with respect to the cutter unit 14. This gap better permits the skin therein to stretch and thus enhances the tautening of the skin in advance of the cutter unit when the scraper edge 15d is pressed into the skin as described above.

FIG. 6 illustrates a construction similar to that of FIG. 5, also including a holder 23, cutter unit 24 and skin supporting rim 25, corresponding to elements 13, 14 and 15, respectively in FIG. 5. In the modification of FIG. 6, however, the relatively sharp scraper edge is defined by an outward extension 25d of the outer skin-contact face 25c of the skin supporting rim 25 at the juncture of that outer skin-contact face with the outer side face 25b of the rim.

As in FIG. 5, the outer tip of the scraper edge 25d could also be substantially flush with, but preferably is slightly inwardly recessed with respect to, the contact face 25c of the rim 25. In this embodiment, as well as in the embodiment of FIG. 5, the outer skin-contact face 25c may also be slightly rounded so as to produce a minimum of irritation of the skin during normal shaving operation, but to permit the scraper edge to become effective to erect the hairs and to tauten the skin, whenever desired, by merely slightly tilting the electrical razor obliquely as described above with respect to FIG. 5. The inner face of the rim 25 in FIG. 6 is also provided with a recess to define a space or gap 26 for enhancing the tautening of the skin as described above with respect to FIG. 5.

FIG. 7, and its sectional view shown in FIG. 8, illustrate another embodiment of the invention wherein the relatively sharp scraping edge is formed in the holder 33 of the cutter head between the skin engaging rims 35 and the outer edge of the holder. Thus, as shown in FIGS. 7 and 8, each cutter unit 34 is also circumscribed by a skin supporting rim 35, which in this case may be of the conventional rounded configuration described for example in the above-cited U.S. Pat. No. 5,625,950. Here, however, the relatively sharp scraping edge formation, generally designated 40, is formed in the holder 33 outwardly of the rims 35, i.e., between the rims of the cutter units and the outer edge of the holder.

The shaver in FIG. 7 includes three cutter units 34 arranged in a triangular array; and the holder 33 incorporates three such relatively sharp scraping edge formations 40 along each side of the triangular array such that each bridges two cutter units at the respective side.

In the present commercial version of the electrical shaver, the holder 33 is made of a plastic material. Each of the relatively sharp scraper formations 40 may thus be formed by producing an elongated groove or recess 41 in the holder 33, and inserting an elongated metal insert 42 into the recess, which insert is formed with a relatively sharp edge 43 projecting over the recess 41 to define the scraper edge. Where the holder is of metal, a similar recess and projection may be integrally formed in the metal of the holder.

In the embodiment illustrated in FIGS. 7 and 8, the scraper edge 43 is thus normally out of contact with the skin to be shaved and therefore cannot engage or irritate the skin during a normal shaving operation. Whenever it is desired to effect a scraping action, the electrical shaver would be pivoted to an oblique position, as described earlier, to bring the relatively sharp scraper edge 43 into contact with the skin being shaved, and thereby to erect the hairs and to tauten the skin in advance of the cutter units 34. For example, such a tilting could be effected by a rolling action of the electrical razor at the beginning of selected shaving strokes.

Thus, while the embodiment illustrated in FIGS. 7 and 8 reduce the possibility of irritating the skin during a normal shaving operation, it tends to tauten the skin to a lesser degree just before engaged by the cutter units, than the earlier described embodiments.

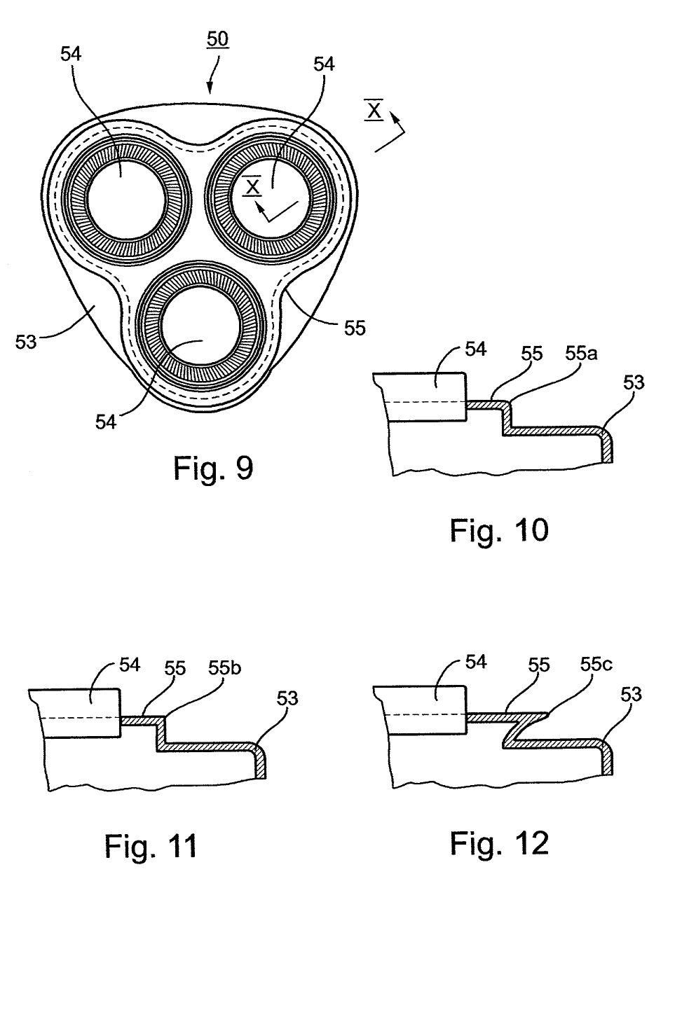

FIGS. 9-12 illustrate further embodiments wherein the invention is implemented in another type of rotary electrical razor, also including a cutter unit holder 53 mounting three cutter units 54 in a triangular array within a skin engaging and supporting surface 55. In this case, however, the skin engaging and supporting surface 55 is not in the form of an individual rim circumscribing each of the cutter units, as described above, but rather is in the form of a slightly elevated table which is common to all the cutter units 54.

FIG. 10 illustrates a known prior art construction of such electrical shavers, wherein it will be seen that the skin supporting table 55 has a flat upper surface in contact with the skin, but is provided with a rounded forward surface 55a so as to facilitate movement of the cutter head over the skin being shaved with a minimum of irritation.

FIGS. 11 and 12 illustrate two manners of modifying the construction of such an electrical shaver in accordance with the present invention to provide a relatively sharp scraper edge on the cutter head 53 to be pressed into the skin forwardly of the cutter units in order to erect hairs in the skin, and to tauten the skin, in advance of the cutter units, as described above with respect to FIGS. 5-8.

FIG. 11 illustrates a construction similar to that in FIG. 5 wherein the relatively sharp scraper edge, shown at 55b, is defined by a sharp corner in the outer edge of the skin supporting table 55; whereas FIG. 12 illustrates a construction similar to that of FIG. 6, wherein the relatively sharp scraper edge, shown at 55c, is defined by an outward extension of the outer contact face of the skin supporting table 55 with its outer side face. It will be appreciated that either or both of the above constructions could be provided with recesses around each of the cutter units 54 to define gaps corresponding to gaps 16 and 26 in FIGS. 5 and 6 to enhance the skin-tautening function of the scraper edge as described above with respect to FIGS. 5 and 6.

While the invention has been described above with respect to one particular type of rotary electric shaver, it will be appreciated that it could be implemented in many other types of shavers, including also the oscillatory type shavers. To better enable its use with soap and water or while showering, it could be implemented in an electrical shaver having a magnetic coupling between the electrical motor and the shaver units, as described for example in my U.S. Pat. No. 6,226,870, or in my co-pending patent application Ser. No. 09/610,467, filed Jul. 5, 2000. It could also be included in an attachment for electrical shavers as described in my pending application Ser. No. 09/718,347 filed Nov. 24, 2000. Another possible implementation would be in dry electrical shavers, particularly one having the air impeller feature described in my U.S. Pat. No. 5,909,928, in order to provide the above-described hair erecting and skin-tautening advantages also for such dry electrical shavers.

Many other variations, modifications and applications of the invention will be apparent.

What is claimed is:

1. A shaver for shaving hair from skin, comprising:
a manually-grippable housing, and a cutter head carried by said housing;
said cutter head including a holder having at least one cutter unit to be pressed into contact with, and to be moved along, the skin to be shaved, and a skin engaging surface circumscribing said cutter unit;
characterized in that said cutter head further includes at least one relatively sharp scraper edge located on said cutter head so as to be pressable into said skin forwardly of the cutter unit, to erect hairs in said skin, and to tauten said skin, in advance of said cutter unit as said cutter head is moved across said skin.

2. The shaver according to claim 1, wherein said relatively sharp scraper edge is located on said cutter head such that the relatively sharp scraper edge is pressed into the skin to erect the hairs, and to tauten the skin, by tilting the cutter head with respect to said skin to bring the axis of the cutter head to an oblique angle with respect to said skin.

3. The shaver according to claim 2, wherein said relatively sharp scraper edge is defined by an edge of said skin engaging surface.

4. The shaver according to claim 3, wherein said skin engaging surface has an inner side face facing the cutter unit, an outer side face facing away from the cutter unit, and an outer skin-contact face joining said inner and outer side faces; said relatively sharp scraper edge being formed in the juncture of said outer skin-contact face with said outer side face.

5. The shaver according to claim 4, wherein said relatively sharp scraper edge is defined by a sharp corner at said juncture.

6. The shaver according to claim 4, wherein said relatively sharp scraper edge is defined by an outward extension of said outer contact face at said juncture.

7. The shaver according to claim 1, wherein said skin engaging surface is in the form of a rim circumscribing said cutter unit.

8. The shaver according to claim 7, wherein said rim includes an outer face formed with said relatively sharp scraper edge, and an inner face formed with a recess defining a gap with respect to said cutter unit to enhance the tautening of the skin in advance of the cutter unit.

9. The shaver according to claim 7, wherein said cutter head includes a plurality of said cutter units and a plurality of said rims each circumscribing its respective cutter unit.

10. The shaver according to claim 1, wherein said cutter head includes a plurality of said cutter units and a common skin engaging surface in the form of an elevated table within which all said cutter units are located, said scraper edge being formed in the outer face of said elevated table.

11. The shaver according to claim 1, wherein said relatively sharp scraper edge is formed in said holder between said skin engaging surface and an outer edge of the holder.

12. The shaver according to claim 11, wherein said relatively sharp scraper edge is defined by a relatively sharp projection extending over a recessed formation formed in said holder between said relatively sharp projection and the outer edge of the holder.

13. The shaver according to claim 12, wherein said holder is of plastic, and said relatively sharp projection defining said scraper edge is a metal insert seated within said recess.

14. The shaver according to claim 11, wherein said cutter head includes a plurality of said cutter units, and said relatively sharp scraper edge is formed in said holder at least along one side thereof between at least two of said cutter units and the respective outer edge of the holder.

15. The shaver according to claim 14, wherein said cutter head includes three of said cutter units arranged in a triangular array, and said relatively sharp scraper edge is formed in said holder at least along one of the three sides of said triangular array.

16. The shaver according to claim 1, wherein said cutter unit includes an outer cutter member formed with a plurality of hair-entry slits, and an inner cutter member rotatable within said outer cutter member to cut the hairs received within said hair-entry slits.

17. An electrical shaver for shaving hair from skin, comprising:
a manually-grippable housing having a cutter head removably attachable thereto along an outer edge of the cutter head;
said cutter head including a holder having a skin engaging surface to engage the skin to be shaved, and a plurality of cutter units within said skin engaging surface to be pressed into contact with, and to be moved along, the skin to be shaved;
said cutter head further including at least one relatively sharp scraper edge located on said cutter head such that, when the cutter head is tilted with respect to said skin to bring said skin engaging surface of the cutter head to an oblique angle with respect to said skin, said relatively sharp scraper edge is pressed into said skin forwardly of the cutter units to erect hairs in said skin, and to tauten said skin, in advance of said cutter units as said cutter head is moved across said skin.

18. The shaver according to claim 17, wherein said relatively sharp scraper edge is defined by an outer edge of said skin engaging surface.

19. The shaver according to claim 17, wherein said relatively sharp scraper edge is formed in said holder between said skin engaging surface and an outer edge of the holder.

20. The shaver according to claim 17, wherein each of said cutter units includes an outer cutter member formed with a plurality of hair-entry slits, and an inner cutter member rotatable within said outer cutter member to cut the hairs received within said hair-entry slits.
